(19) United States
(12) Patent Application Publication
(10) Pub. No.: US 2008/0297111 A1
(43) Pub. Date: Dec. 4, 2008

(54) ALKALINE BATTERY CHARGER WITH UNIVERSAL CONNECTORS

(76) Inventor: Gary A. Fisher, Hong Kong (CN)

Correspondence Address: EDWARDS ANGELL PALMER & DODGE LLP, P.O. BOX 55874, BOSTON, MA, 02205, US

(21) Appl. No.: 12/131,323

(22) Filed: Jun. 2, 2008

Related U.S. Application Data
(60) Provisional application No. 60/932,720, filed on Jun. 1, 2007.

(51) Int. Cl. H02J 7/00

(52) U.S. Cl. 320/110

(57) ABSTRACT

An alkaline battery charger with universal connectors for the charging of alkaline batteries of type AA, AAA, C, and D includes a spring loaded slide bar, moving charging studs fixed into the spring loaded slide bar, a battery tray, four fixed lower charging studs, two fixed middle charging studs, two fixed upper charging studs, a safety cut off switch, a cover, an LCD showing charging status of each battery, and a PCB including independent circuitry for self monitoring which detects faults and places the unit into a safe operating mode.

### CROSS-REFERENCE TO RELATED APPLICATIONS

This application claims benefit of priority to U.S. Provisional Application Ser. No. 60/932,720 filed Jun. 1, 2007, which is incorporated by reference herein in its entirety.

### BACKGROUND OF THE INVENTION

1. Field of the Invention

The present invention relates generally to battery chargers and more specifically it relates to Alkaline battery chargers for the charging of Alkaline batteries of type AA, AAA, C, and D.

2. Description of the Related Art

It can be appreciated that Alkaline battery chargers have been in use for years. Typically, Alkaline battery chargers are comprised of a charging Tray with fixed connectors which connect to only one battery type at a time. More recently the charging Tray has been used to charge more than one type of Alkaline battery at a time, however identifying the battery and then selecting the correct electrical charging current requirement has become of importance. Recently electrical charging current has been selected using mechanical posts that are connected to electrical switches underneath the battery charging Tray as in U.S. Pat. No. 6,610,941 B2. Physical depression of these posts as the battery is inserted actuates electrical switches which select the correct electrical current for charging.

The main problem with the conventional Alkaline battery charger is that traditional designs make the charger larger and more complex than need be. Another problem with the conventional Alkaline battery charger is the lack of a safety electrical shut off mechanism. In recent designs such as U.S. Pat. No. 6,610,941 B2, where electrical charging current is determined by physical posts which are depressed by the battery case and actuate electrical switches, safety is potentially compromised should faulty electrical switching occur. In such a situation possible leakage/rapture or even explosion of the battery may occur. Another problem with the conventional Alkaline battery charger is that the charger does not switch off if the lid is opened, nor does the charger know when an electrical fault has occurred and is unable to switch itself automatically into a safe operating mode. At present charging status indication is limited to LED indicators, and no prior art shows a charger of this type with an LCD giving charge status indication for each battery.

While these devices may have been suitable for the particular purpose to which they address, they are not ideally suitable for the charging of Alkaline batteries of type AA, AAA, C, and D. In these respects, there is still a need in the art for Alkaline battery chargers with improved universal connectors. There is also a need in the art for such alkaline battery chargers that are adapted for the purpose of the charging Alkaline batteries of type AA, AAA, C, and D. The present invention provides a solution for these problems.

### SUMMARY OF THE INVENTION

The present invention is directed to an alkaline battery charger. More particularly, the subject invention is directed to a battery charger comprising a main housing having a plurality of fixed charging studs adjacent one end thereof. Each of the fixed charging studs is configured and adapted to be electrically connected to a terminal of a battery of a predetermined size for charging thereof. A battery tray is operatively connected to the main housing and includes a plurality of battery receiving surfaces. Each battery receiving surface is configured and adapted to receive and align a terminal of a battery of a predetermined size with one of the fixed charging studs of the main housing for charging. A slide bar is operatively connected to the main housing opposite the fixed charging studs and includes at least one charging stud operatively connected thereto. The slide bar is configured and adapted to bias opposed terminals of a battery between the at least one charging stud of the slide bar and one of the fixed charging studs of the main housing for charging. Charging means are electrically connected to the fixed charging studs of the main housing and to the at least one charging stud of the slide bar. The charging means is configured and adapted to provide charging conditions to batteries of various predetermined sizes wherein the charging conditions are based on battery size.

In one aspect, the plurality of fixed charging studs includes four charging studs configured to be electrically connected to type AA and/or type AAA batteries, two charging studs configured to be electrically connected to type C batteries, and two charging studs configured to be electrically connected to type D batteries. The battery tray can include battery receiving surfaces configured to receive up to four batteries of AAA and AA type, battery receiving surfaces configured to receive up to two batteries of C type, and battery receiving surfaces configured to receive up to two batteries of D type, wherein the battery receiving surfaces are each configured to align a battery received therein with a corresponding one of the fixed charging studs. The charging means can be configured and adapted to provide charging conditions to batteries of type AAA, AA, C, and D based on which type of battery is connected thereto.

In another aspect, the battery charger includes a cover operably connected to the main housing. The cover is configured for movement between a closed position adapted to provide a protective covering over batteries charging in the battery tray and an open position adapted to provide access for placement and removal of batteries within the battery tray. An electrical switch can be provided operably connected to the cover, wherein the electrical switch is configured to close a circuit including the charging means when the cover is in the closed position and to open the circuit when the cover is in the open position. It is also contemplated that the battery charger can further include a display operably connected to the main housing and charging means, the display being configured and adapted to display charging status information.

In view of the foregoing disadvantages inherent in the known types of Alkaline battery charger now present in the prior art, the present invention provides a new Alkaline battery charger with universal connectors, with built in safety features and a digital display to show charging status wherein the same can be utilized for the charging of Alkaline batteries of type AA, AAA, C, and D.

The general purpose of the present invention, which will be described subsequently in greater detail, is to provide a new Alkaline battery charger with universal connectors that has many of the advantages of the Alkaline battery chargers mentioned heretofore and many novel features that result in a new Alkaline battery charger with universal connectors which is not anticipated, rendered obvious, suggested, or even implied by any of the prior art Alkaline battery chargers, either alone or in any combination thereof.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an Alkaline battery charger with universal connectors that will overcome the shortcomings of the prior art devices. An object of the present invention is to provide an Alkaline battery charger with universal connectors for the charging of Alkaline batteries of type AA, AAA, C, and D. Another object is to provide an Alkaline battery charger with universal connectors that charges Alkaline batteries but which uses a unique connector system to determine which battery is present and selects the correct charging conditions without the need of complex mechanical mechanism or electrical switches.

Another object is to provide an Alkaline battery charger with universal connectors that will uniquely determine and indicate on a display whether an Alkaline battery is incapable of being charged, or is being charged or has completed it's charging. Another object is to provide an Alkaline battery charger with universal connectors with an independent circuit inside the device that self monitors for fault conditions and automatically sets the charger into a safe operating mode when a fault is detected. Another object is to provide an Alkaline battery charger with universal connectors in which the cover has an associated electrical switch which shuts off charging current to the batteries when the cover is opened. Another object is to provide an Alkaline battery charger with universal connectors that will display the charge level and status of each battery by using a digital display.

These and other features, objects, and advantages of the present invention will become more readily apparent to those having ordinary skill in the art from the following enabling description of the preferred embodiments of the subject invention taken in conjunction with the several drawings described below. and it is intended that these objects and advantages are within the scope of the present invention.

### BRIEF DESCRIPTION OF THE DRAWINGS

So that those skilled in the art to which the subject invention appertains will readily understand how to make and use the charger of the subject invention without undue experimentation, preferred embodiments thereof will be described in detail hereinbelow with reference to certain figures, wherein:

FIG. 1a is a perspective view of the present invention from the rear with the top cover (8) removed for clarity clearly indicating the Spring Loaded Slide Bar (1), the Moving Charging Studs (2) fixed into the Spring Loaded Slide Bar (1), the Battery Tray (3) and LCD Display (9);

FIG. 1b is a perspective view of the present invention from the front with the top cover (8) removed for clarity clearly indicating the Spring Loaded Slide Bar (1), the Battery Tray (3), the Four Lower Fixed Charging Studs (4), the Two Middle Fixed Charging Studs (5), the Two Upper Fixed Charting Studs (6) and the LCD Display (9);

FIG. 2 is an exploded view of the present invention illustrating all of the components, indicating clearly the Spring Loaded Slide Bar (1), the Moving Charging Studs (2) fixed into the Spring Loaded Slide Bar (1), the Battery Tray (3), the Four Lower Fixed Charging Studs (4), the Two Middle Fixed Charging Studs (5), the Two Upper Fixed Charging Studs (6), the Safety Cut-off Switch (7), the Cover (8), the LCD showing Battery Charge Status (9) and the PCB Including Independent Circuitry for Self Monitoring (10);

FIG. 3a is a side elevation view of the present invention clearly indicating the Spring Loaded Slide Bar (1), the Moving Charging Studs (2) fixed into the Spring Loaded Slide Bar (1), the Battery Tray (3), the Lower Fixed Charging Studs (4), the Safety Cut-off Switch (7);

FIG. 3b is a cross sectional side elevation view of the present invention clearly indicating the Two Middle Fixed Charging Studs (5), the Two Upper Fixed Charging Studs (6), the Cover (8), the LCD showing Battery Charge Status (9) and the PCB Including Independent Circuitry for Self Monitoring (10);

FIG. 4a is a top view of the charging Tray without the main body case clearly indicating the mechanics of the assembly when two D-Cells are inserted; also shown are Spring Loaded Slide Bar (1), the Moving Charging Studs (2) fixed into the Spring Loaded Slide Bar (1), the Battery Tray (3), the Two Upper Fixed Charging Studs (6);

FIG. 4b is a side elevation view of the charging Tray without the main body case clearly indicating the mechanics of the assembly when two D-Cells are inserted; also shown are Spring Loaded Slide Bar (1), the Moving Charging Studs (2) fixed into the Spring Loaded Slide Bar (1), the Battery Tray (3), the Two Upper Fixed Charging Studs (6);

FIG. 4c is a rear view of the charging Tray without the main body case clearly indicating the mechanics of the assembly when two D-Cells are inserted; also shown are the Battery Tray (3), the Four Lower Fixed Charging Studs (4), the Two Middle Fixed Charging Studs (5), the Two Upper Fixed Charging Studs (6);

FIG. 4d is a bottom view of the charging Tray without the main body case clearly indicating the mechanics of the assembly when two D-Cells are inserted; also shown are the Battery Tray (3), the Four Lower Fixed Charging Studs (4), the Two Middle Fixed Charging Studs (5), the Two Upper Fixed Charging Studs (6);

FIG. 4e is a side elevation view of the charging Tray without the main body case clearly indicating the mechanics of the assembly when two D-Cells are inserted. Clearly shown are Spring Loaded Slide Bar (1), the Battery Tray (3), the Lower Fixed Charging Studs (4), the Middle Fixed Charging Studs (5), the Upper Fixed Charging Studs (6);

FIG. 4f is a cross sectional front view of the charging Tray without the main body case clearly indicating the mechanics of assembly when two D-cells are inserted; also shown are the Battery Tray (3), the Four Lower Fixed Charging Studs (4), and the two D-Cells; and

FIG. 5. is a cross sectional front view of the charging tray without the main body case clearly indicating the typical dimensions between the various fixed charging studs, namely the lower fixed charging studs (4), the middle fixed charging studs (5), and the upper fixed charging studs (6); also shown is the cross sectional view of the Battery tray (3), and exemplary dimensions.

### DETAILED DESCRIPTION OF THE INVENTION

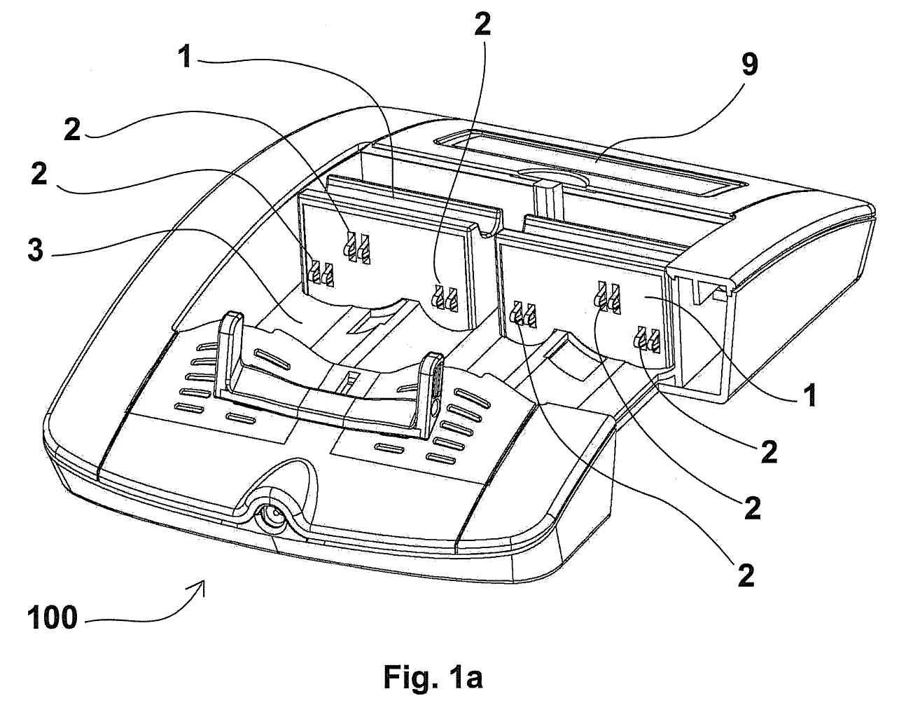

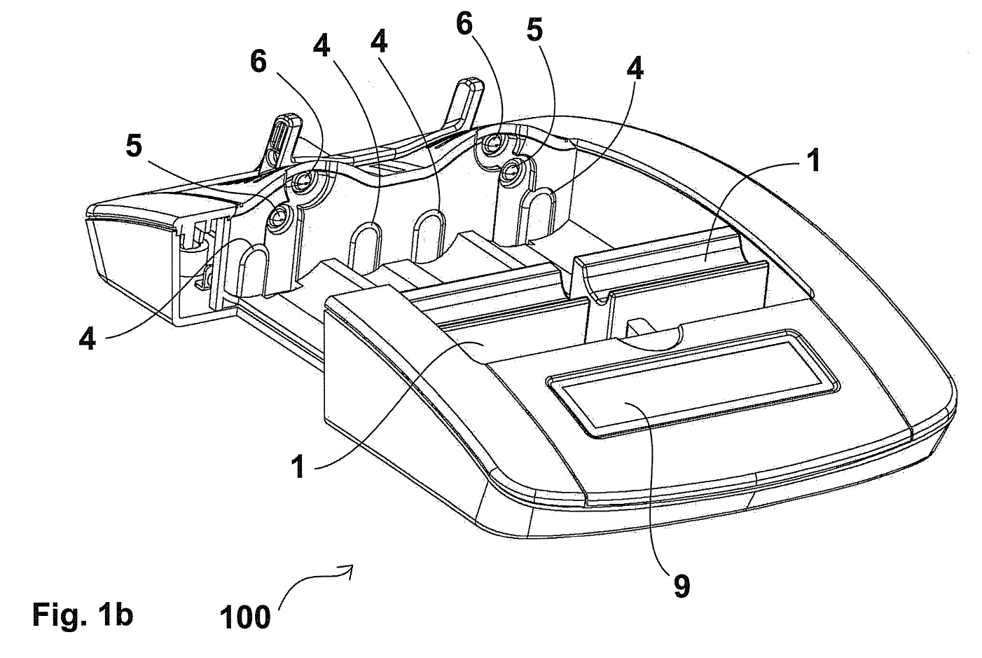

Referring now to the drawings, wherein like reference numerals identify or otherwise refer to similar structural features or elements of the various embodiments of the subject invention, there is illustrated in FIG. 1a, by way of explanation and illustration and not limitation, an exemplary charger constructed in accordance with the subject invention and designated generally by reference numeral 100. Other embodiments of a charger in accordance with the invention, or aspects thereof, are provided in FIGS. 1b-5 of the attached figures.

FIG. 1 illustrates an Alkaline battery charger with universal connectors, which comprises A Spring Loaded Slide Bar (1), Moving Charging Studs (2) fixed into the Spring Loaded Slide Bar (1), a battery Tray (3), four Lower Fixed Charging Studs (4), two Middle Fixed Charging Studs (5), two Upper Fixed Charging Studs (6), a Safety Cut Off Switch (7), a Cover (8), an LCD showing Battery Charge Status (9) of each battery, and a PCB Including Independent Circuitry for Self Monitoring (10).

The Spring Loaded Slide Bar (1) is a mechanical moveable holder which mechanically ensures contact between the battery and the Moving Charging Studs (2) fixed into the Spring Loaded Slide Bar. The Spring Loaded Slide Bar (1) moves horizontally along the same orientation as the battery in the long axis of the battery. It's purpose is to physically hold the battery in place. It accommodates different battery sizes and prevents unwanted mechanical movement. This can be achieved alternatively by an Angled Spring, Direct Spring, fixed Block with Spring Loaded terminals.

Moving Charging Studs (2) fixed into the Spring Loaded Slide Bar (1). The purpose of these Moving Charging Studs (2) fixed into the Spring Loaded Slide Bar (1) is to connect electrically the charging circuit to one terminal of the battery. This can be achieved by either Fixed Studs, or Spring Loaded Studs. The Battery Tray (3) holds the batteries in place and prevents them from moving from side to side and also correctly positions the battery to the electrical contacts. This can be achieved by a flat surface with half curved stepped surfaces or a flat surface with flat stepped surfaces.

Four lower Charging Studs (4) provides the electrical contacts for AA, AAA Alkaline batteries only, these Studs connect to the battery terminal. These can be ether fixed or Spring Loaded. Two Middle fixed charging Studs (5). Provides the electrical contacts for C Type Alkaline batteries, these Studs connect to the battery terminal. These can be ether fixed or Spring Loaded. Two Upper fixed charging Studs (6) provide the electrical contacts for D Type Alkaline batteries, these Studs connect to the battery terminal. These can be ether fixed or Spring Loaded.

The main housing 115 of the unit comprises of a plastic case with a hinged Cover (8). The Cover (8) provides the user with protection from Chemicals in the event of leakage/rupture or even explosion of the batteries. The Cover (8) provides additional safety from splashing of chemicals in the event of a battery failure/rupture/explosion. This Cover (8) can be Hinged, Sliding, Detachable, or of any other suitable configuration. Safety Cut-off Switch (7) cuts off the power to the batteries when the cover is opened for added safety. This can be any Physically actuated Electrical Switch, Optical Switch, Magnetic Switch or any other device capable of detecting whether the Cover (8) is open or closed.

LCD showing Battery Charge Status (9) provides a visual reference of the battery charge status including the charging progress. The LCD Showing Battery Charge Status (9) also indicates if a battery is faulty and also when an Alkaline battery is fully charged. The LCD display can convey the information as icons, symbols like progress bars or other bar symbols, characters, numerals, or any other suitable means of conveying the information. This display can also be an LED display, and may utilize a number of various alternate symbols to represent charge state rather than a series of Bars, or other suitable symbols. Other Audio-Visual alarms may be employed including voice alarm to give notification of the unit operating state and the state of the charging Alkaline batteries.

The PCB (printed circuit board) including Independent monitoring circuit/circuitry for Self Monitoring (10) provides additional safety. The PCB Including Independent Circuitry for Self Monitoring (10) monitors the charging circuit for any faults, if detected the PCB Including Independent Circuitry for Self Monitoring (10) sets the device into a safe operating mode. This can be an Analogue Circuit, Digital Circuit, utilizing Discrete Components or be custom manufactured in a Chip, or Multi-Chip Module, or combinations thereof.

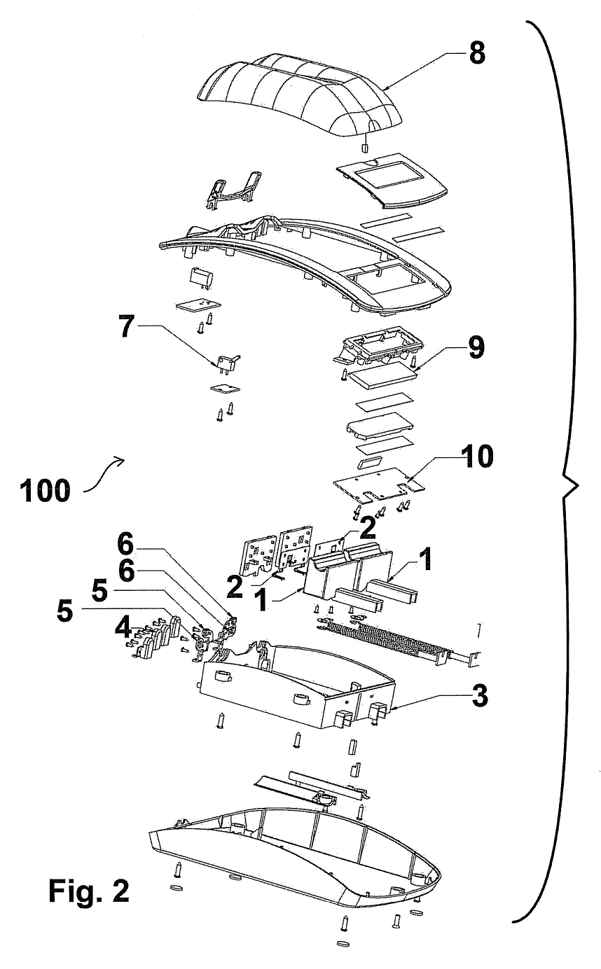

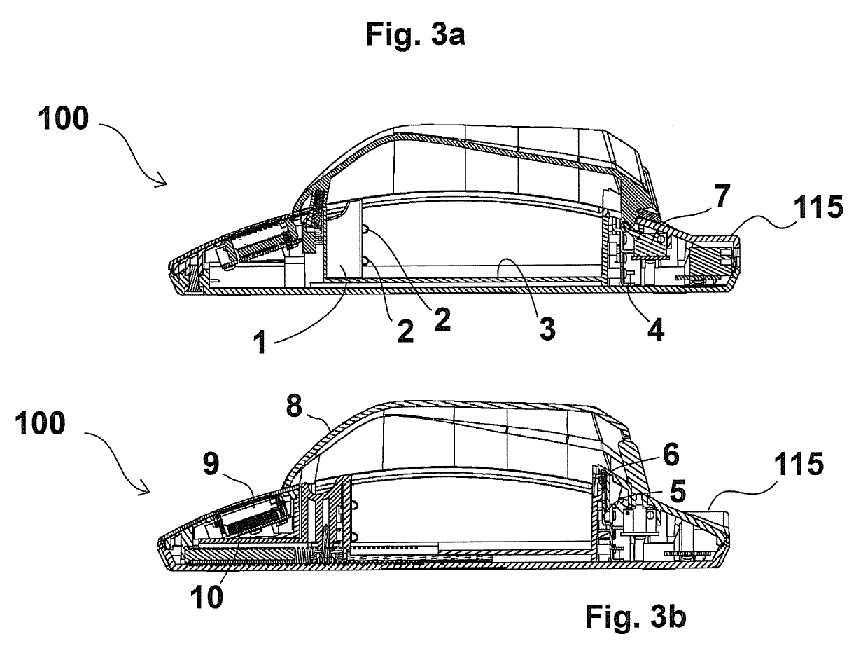

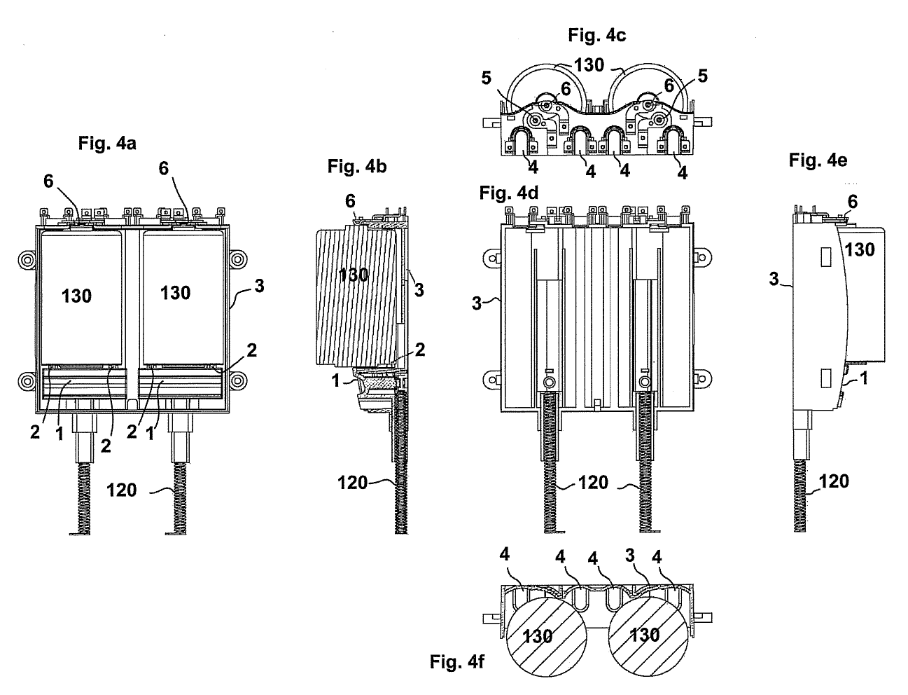

On the front of the case is the LCD showing Battery Charge Status (9) as shown in FIG. 1(a-b), FIG. 2 and FIG. 3b. Once the Cover (8) is opened two things occur, firstly the Cover (8) opening actuates an electrical switch (7) as shown in FIG. 2 and FIG. 3a which cuts off all electrical charging to the Battery Tray (3) inside. Secondly with the Cover (8) open, the user can access the Battery Tray (3) shown in FIG. 1a, FIG. 1b and FIG. 4(a,b,c,d,e) and can insert or remove batteries accordingly. Inside the battery Tray (3) there are a number of battery holding groves as indicated in FIG. 1a, FIG. 1b and FIG. 4f, these groves give the user the ability to insert four different Alkaline battery types, AA, AAA, C and D or a combination of these Alkaline Battery types.

To insert a battery, the user pulls back slightly on the Spring Loaded Slide Bars (1) as indicated in FIG. 1(a), FIG. 1(b), FIG. 2, FIG. 3a and FIG. 4(a,b,d,e). The Spring Loaded Slide Bars (1) move along on the same long axis as the oriented battery. Once sufficient mechanical clearance is generated by this action, the user can insert the battery into the battery Tray (3) as shown in FIG. 4(a,b,c,d,e,f) for two D Type Alkaline batteries as one example. The Spring Loaded Slide bar (1) can then be released, the Springs 120 as shown in FIG. 2, FIG. 4(a,b,d,e) will then push the moving charging Studs (2) which are fixed into the Spring Loaded Slide Bar (1) onto the battery terminal to form and electrical connection as shown in FIG. 4(a,b,c,d,e).

At the other end of the battery, the other battery terminal aligns up and electrically connects to one of the fixed charging Studs depending on its size and type (i.e. AA, AAA, C or D type Alkaline batteries) for example for D type Alkaline batteries 130 as in FIG. 4 (a,b,c,d,e). For AA and AAA type Alkaline batteries alignment will only occur with the Lower Fixed Charging Studs (4), while for C type Alkaline batteries alignment will only occur with the Middle Fixed Charging Studs (5) and finally for D type Alkaline batteries (as shown in FIG. 4), alignment will only occur with the Upper Fixed Charging Studs (6). The physical dimension of the Alkaline battery (and thus it's type i.e. AA, AAA, C or D) determines which charging stud the battery aligns to and thus electrically connects to thus eliminating any need for electrical switching to decide the charging current required, thus overcoming the shortcomings of Prior Art devices aforementioned.

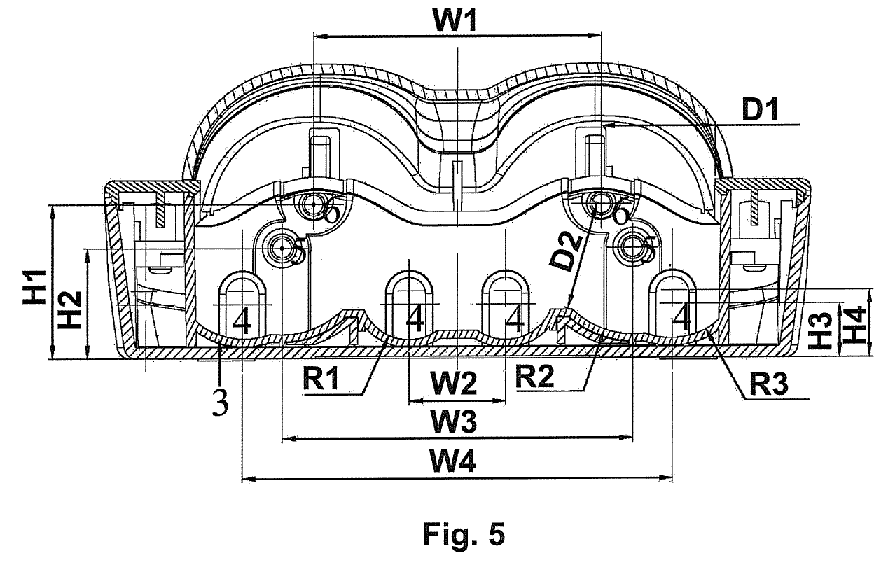

This mechanical alignment is achieved by the Battery Tray (3) design, whose cross section is indicated in FIG. 1(a), FIG. 1(b) and most clearly in cross section in FIG. 4(f) and FIG. 5. The lower fixed charging Studs (4) align with AA and AAA type Alkaline batteries only, while the Middle Fixed Charging Studs (5) align only to C type Alkaline batteries and the Upper Fixed Charging Studs (6) align only with D type Alkaline batteries.

Once the batteries are correctly inserted and the Cover (8) is closed, the electrical switch (7) is actuated by the Cover (8) and this indicates to the PCB with Independent Circuitry for Self Monitoring (10) to start testing the Alkaline batteries to determine whether they are capable of being charged. If they are not capable of being charged then this is indicated on the LCD Display Showing Charging Status (9) and no charging current is sent to that battery. If they are capable of being charged then the PCB with Independent Circuitry for Self Monitoring (10) starts the charging process and indicates the status on the LCD Display Showing Charging Status (9). All through the charging process the PCB including Independent Circuitry for Self Monitoring (10) independently monitors for faults or irregularity with the batteries. If irregularity or fault are detected then the PCB Including Independent Circuitry for Self Monitoring (10) sets the unit into a safe operating mode which may include full reset which causes the battery testing cycle to begin again, or shutting off of power to the unit accordingly.

The LCD showing Charging Status (9) could be replaced by an LED display and the charging status which preferably is in the form of a series of Bars on the display could be replaced by another symbol, such as described above, or representation of the charging status, further audio visual alarms could be incorporated and include Audio Alarms and Voice indications. The Charging Tray (3) could be either a flat surface with curved grooves, or a flat surface with stepped groves to achieve the same effect, and an implied variation of the embodiment. The Cover (8) can be Hinged, Sliding, Detachable, or of any other suitable configuration. The Lower Fixed Charging Studs (4) can also be spring loaded. The Middle Fixed Charging Studs (5) can also be Spring loaded. The Upper Fixed Charging Studs (6) can also be spring loaded.

The Number of Charging Studs can be increased or decreased depending on how many batteries are to be charged and this is represented in other models of the same design. The number of Studs specified represents one design which is capable of charging either two D type Alkaline Batteries, two C type Alkaline Batteries, four AA type Alkaline Batteries or four AAA type Alkaline Batteries or a combination of each, for example one D type Alkaline Battery and two AA type Alkaline Batteries simultaneously. Those skilled in the art will readily appreciate that chargers with lower or higher number of Alkaline Battery Types to be charged can be practiced without departing from the spirit and scope of the invention, as can variations in the dimensions to achieve the same result.

The Safety Cut-off Switch (7) can be any physically actuated electrical Switch, Optical Switch, magnetic switch or any other device capable of detecting whether cover (7) is open or closed and is an implied variation of the embodiment, which will be readily appreciated by those skilled in the art. Moreover, the PCB including Independent Circuitry for self monitoring (10) can be an Analogue Circuit, Digital Circuit, utilize Discrete Components or be custom manufactured in a Chip, or Multi-Chip Module, or combinations thereof, without departing from the scope of the invention.

FIG. 5 shows dimensions for locating various features of charger 100. Exemplary values for the dimensions are as follows: W1=43.6 mm, W2=14.6 mm, W3=53.2 mm, W4=65.2 mm, H1=23.4 mm, H2=16.8 mm, H3=8.2 mm, H4=10.2 mm, R1=7.4 mm, R2=13.3 mm, R3=11.0 mm, D1=17.19 mm, and D2=16.61 mm. Those skilled in the art will readily appreciate that these dimensions are exemplary only, and that any other suitable dimensions can be used without departing from the spirit and scope of the invention.

With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

The chargers of the present invention, as describe above and shown in the drawings, provide for a chargers with superior properties including improved safety measures, improved charging information display, and improved ability to provide universal charging for batteries of type AAA, AA, C, and D. It will be apparent to those skilled in the art that various modifications and variations can be made in the chargers and methods of charging of the present invention without departing from the spirit or scope of the invention. Thus, while the charger has been described above with respect to preferred embodiments, those skilled in the art will readily appreciate that changes and modifications may be made thereto without departing from the spirit and scope of the subject invention as defined by the appended claims.

What is claimed is:

1. A battery charger comprising:
a) a main housing including a plurality of fixed charging studs adjacent one end thereof, each of the fixed charging studs being configured and adapted to be electrically connected to a terminal of a battery of a predetermined size for charging thereof;
b) a battery tray operatively connected to the main housing and including a plurality of battery receiving surfaces, each being configured and adapted to receive and align a terminal of a battery of a predetermined size with one of the fixed charging studs of the main housing for charging;
c) a slide bar operatively connected to the main housing opposite the fixed charging studs and including at least one charging stud operatively connected thereto, wherein the slide bar is configured and adapted to bias opposed terminals of a battery between the at least one charging stud of the slide bar and one of the fixed charging studs of the main housing for charging; and
d) charging means electrically connected to the fixed charging studs of the main housing and to the at least one charging stud of the slide bar, wherein the charging means is configured and adapted to provide charging conditions to batteries of various predetermined sizes wherein the charging conditions are based on battery size.

2. A battery charger comprising:
a) a main housing including a plurality of fixed charging studs adjacent one end thereof, each of the fixed charging studs being configured and adapted to be electrically connected to a terminal of a battery of a predetermined size for charging thereof, wherein the plurality of fixed charging studs includes four charging studs configured to be electrically connected to type AA and type AAA batteries, two charging studs configured to be electrically connected to type C batteries, and two charging studs configured to be electrically connected to type D batteries;
b) a battery tray operatively connected to the main housing and including battery receiving surfaces configured to receive up to four batteries of AAA and AA type, battery receiving surfaces configured to receive up to two batteries of C type, and battery receiving surfaces configured to receive up to two batteries of D type, wherein the battery receiving surfaces are each configured to align a battery received therein with a corresponding one of the fixed charging studs;
c) a pair of slide bars each operatively connected to the main housing opposite the fixed charging studs and including at least one charging stud operatively connected thereto, wherein each slide bar is configured and adapted to bias opposed terminals of a battery between the at least one charging stud of the slide bar and one of the fixed charging studs of the main housing for charging; and
d) charging means electrically connected to the fixed charging studs of the main housing and to the at least one charging stud of each of the slide bars, wherein the charging means is configured and adapted to provide charging conditions to batteries of type AAA, AA, C, and D based on which type of battery is connected thereto.

3. A battery charger as recited in claim 2, further comprising a cover operably connected to the main housing, wherein the cover is configured for movement between a closed position adapted to provide a protective covering over batteries charging in the battery tray and an open position adapted to provide access for placement and removal of batteries within the battery tray.

4. A battery charger as recited in claim 3, further comprising an electrical switch operably connected to the cover, wherein the electrical switch is configured to close a circuit including the charging means when the cover is in the closed position and to open the circuit when the cover is in the open position.

5. A battery charger as recited in claim 4, further comprising a display operably connected to the main housing and charging means, the display being configured and adapted to display charging status information.
